(19) United States
(12) Patent Application Publication
(10) Pub. No.: US 2012/0113451 A1
(43) Pub. Date: May 10, 2012

(54) METHOD FOR DETECTING WHETHER PAPER IS REMAINED AND MULTI-FUNCTION PRINTER THEREOF

(75) Inventor: Hung-Chieh Chang, Taipei County (TW)

(73) Assignees: Kinpo Electronics, Inc., Taipei County (TW); Cal-Comp Electronics & Communications Company Limited, Taipei County (TW)

(21) Appl. No.: 13/006,433

(22) Filed: Jan. 14, 2011

(30) Foreign Application Priority Data
Nov. 10, 2010 (TW) 99138684

(51) Int. Cl. G06F 3/12

(52) U.S. Cl. 358/1.13; 358/1.15

(57) ABSTRACT

A method for detecting whether a paper is remained and a multi-function printer (MFP) thereof are provided. The method includes executing a detection procedure when the MFP accomplishes image capturing and outputting of the paper; recording a time of starting executing the detection procedure; calculating an executed time of the detection procedure; and determining whether to activate an alarm according to the executed time of the detection procedure and whether a top cover (TC) of the MFP is opened, so as to remind a user whether the paper is remained in the MFP.

### CROSS-REFERENCE TO RELATED APPLICATION

This application claims the priority benefit of Taiwan application serial no. 99138684, filed on Nov. 10, 2010. The entirety of the above-mentioned patent application is hereby incorporated by reference herein and made a part of this specification.

### BACKGROUND OF THE INVENTION

1. Field of the Invention

The present invention relates to a method for detecting whether a paper is remained and a multi-function printer (MFP) thereof.

2. Description of Related Art

With the coming of the information society, office automation equipment, for example, a scanner, a photocopier, or a printer, is set in offices, and a user can perform the word processing operation by using the office automation equipment. It should be noted that when being configured in the office at the same time, the office automation equipment may occupy much space. Therefore, an MFP integrating functions of photocopying, printing, and scanning is developed. However, when many users scan or photocopy the paper by using the MFP, a problem that the paper is remained in the MFP occurs.

### SUMMARY OF THE INVENTION

Accordingly, the present invention is directed to a method for detecting whether a paper is remained and an MFP thereof, capable of effectively solving a problem that the paper is remained in the MFP.

The present invention provides a method for detecting whether a paper is remained, applicable to an MFP, in which the method includes: executing a detection procedure, when the MFP accomplishes image capturing and outputting of the paper; recording a time of starting executing the detection procedure; calculating an executed time of the detection procedure; and determining whether to activate an alarm according to the executed time of the detection procedure and whether a top cover (TC) of the MFP is opened, so as to remind a user whether the paper is remained in the MFP.

The present invention further provides an MFP, which includes a scan module and a control module. The scan module is used to scan a paper. The control module is coupled to the scan module, for controlling operation of the scan module, and detecting whether the paper is remained in the MFP according to an executed time of a detection procedure and whether a TC of the MFP is opened, when the MFP accomplishes image capturing and outputting of the paper, so as to determine whether to activate an alarm to remind a user.

According to an embodiment of the present invention, the activated alarm may include one or a combination of an indicating text, a sound, and a lamplight.

On the basis of the above, when accomplishing the image capturing and the outputting of the paper, the MFP starts to detect whether the paper is remained in the MFP. Once detecting that the paper is remained in the MFP for a time exceeding a preset time, the MFP activates the alarm, for example, one or a combination of the indicating text, the sound, and the lamplight, so as to remind the user. In this manner, the problem that the paper is remained in the MFP is effectively solved.

It should be noted that the above description and the following embodiments are for the exemplary and demonstrative purpose only, but are not intended to limit the scope of the present invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a schematic outside view of an MFP 10 according to an embodiment of the present invention.

FIG. 1B is a schematic systematic view of an MFP 10 according to an embodiment of the present invention.

FIG. 2 is a schematic view of processes of a method for detecting whether a paper is remained being applicable to an MFP according to an embodiment of the present invention.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

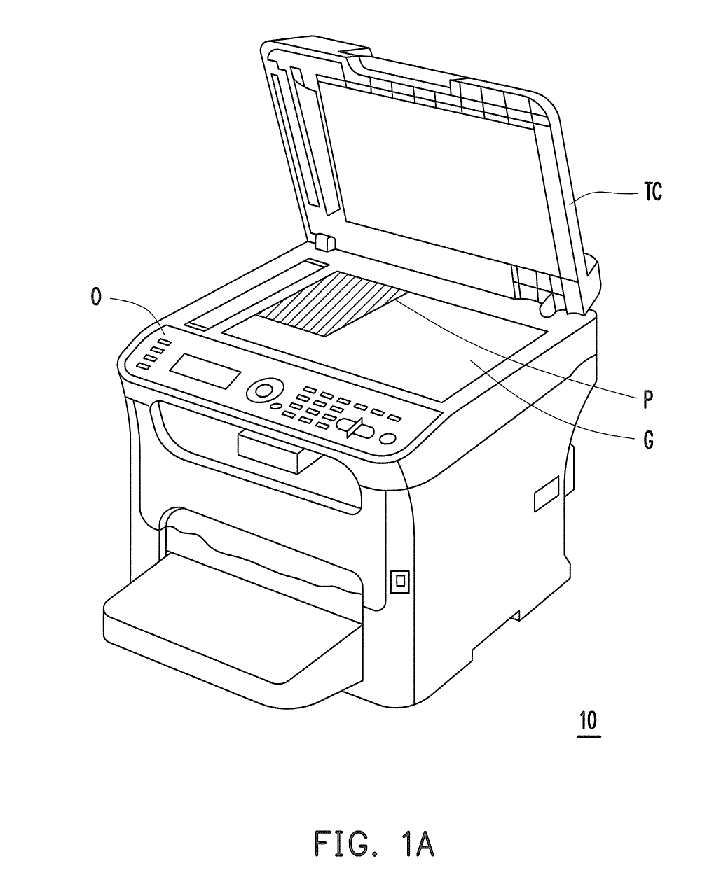

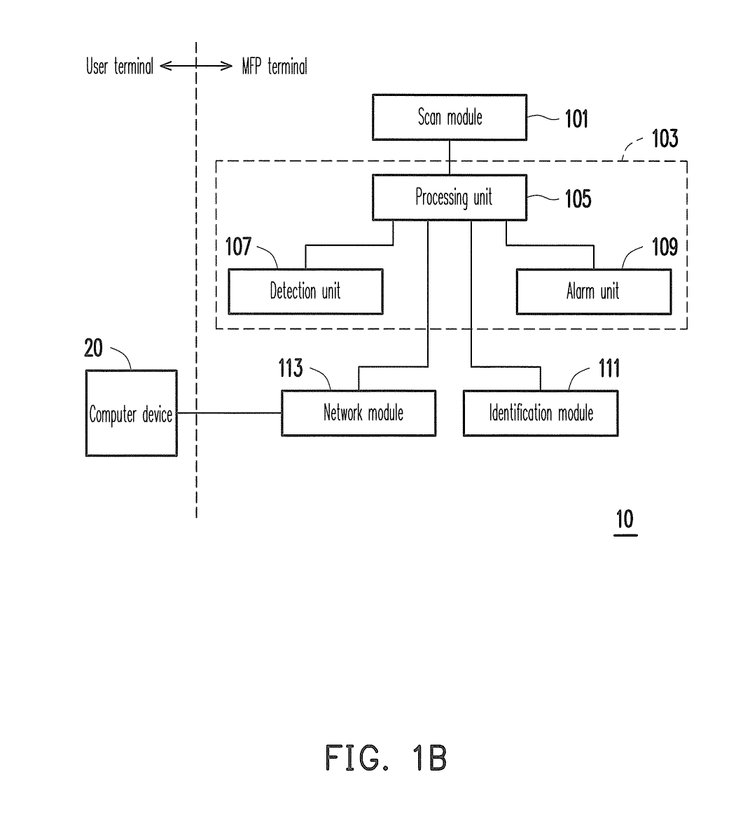

FIG. 1A is a schematic outside view of an MFP 10 according to an embodiment of the present invention, and FIG. 1B is a schematic systematic view of the MFP 10 according to an embodiment of the present invention. Referring to FIG. 1A and FIG. 1B, the MFP 10 of this embodiment at least includes a scan module 101 and a control module 103. The scan module 101 is used to scan a paper P. In addition, the control module 103 is coupled to the scan module 101, for controlling operation of the scan module 101, and detecting whether the paper P is remained in the MFP 10 according to an executed time of a detection procedure and whether a TC of the MFP 10 is opened (described later), when the MFP 10 accomplishes image capturing and outputting of the paper P, so as to determine whether to activate an alarm, for example, one or a combination of an indicating text, a sound, and a lamplight, so as to remind a user.

More specifically, the control module 103 includes a processing unit 105, a detection unit 107, and an alarm unit 109. The processing unit 105 is coupled to the scan module 101, for controlling the operation of the scan module 101, and executing the detection procedure, when the MFP 10 accomplishes the image capturing and the outputting of the paper P. The detection unit 107 is coupled to the processing unit 105, and is controlled by the processing unit 105, so as to detect whether the TC of the MFP 10 is opened. The alarm unit 109 is coupled to the processing unit 105, and is controlled by the processing unit 105, so as to determine whether to activate the alarm, for example, one or a combination of the indicating text, the sound, and the lamplight.

In this embodiment, when the user wants to scan or photocopy the paper P by using the MFP 10, the paper P should be located on a proper location of a transparent glass platform G of the MFP 10, then the TC of the MFP 10 is closed, and finally, the processing unit 105 controls the scan module 101 to scan or photocopy the paper P after performing function setting and activating on an operational panel O.

When the MFP 10 accomplishes the image capturing and the outputting of the paper P, the processing unit 105 starts to execute the detection procedure. Moreover, when the processing unit 105 executes the detection procedure, the processing unit 105 records a time of starting executing the detection procedure, calculates the executed time of the detection procedure, and determines whether to control the alarm unit 109 to activate the alarm, for example, one or a combination of the indicating text, the sound, and the lamplight, according to the executed time of the detection procedure and whether the TC of the MFP 10 is opened.

More specifically, when the processing unit 105 determines that the executed time of the detection procedure is shorter than a preset time (for example, the preset time is one second, but is not limited hereto, and may be adjusted according to actual conditions), the processing unit 105 further controls the detection unit 107 to determine whether the TC of the MFP 10 is opened by the user. Thus, if the processing unit 105 determines that the TC of the MFP 10 is opened by the user through the detection unit 107 (that is, the TC of the MFP 10 is opened by the user in one second), it means that the user does not forget the paper P in the MFP 10. In this manner, the processing unit 105 controls the alarm unit 109 to turn off the alarm, for example, one or a combination of the indicating text, the sound, and the lamplight.

In another aspect, if the processing unit 105 determines that the TC of the MFP 10 is not opened by the user through the detection unit 107 (that is, the TC of the MFP 10 is not opened by the user in one second), it means the user may forget the paper P in the MFP 10. In this manner, the processing unit 105 continuously determines whether the executed time of the detection procedure is still shorter than the preset time (that is, one second). Once the processing unit 105 determines that the executed time of the detection procedure is not shorter than the preset time (that is, the executed time of the detection procedure exceeds one second), the processing unit 105 controls the alarm unit 109 to activate the alarm, for example, one or a combination of the indicating text, the sound, and the lamplight, until the TC of the MFP 10 is opened by the user.

In this embodiment, when the processing unit 105 controls the alarm unit 109 to activate the alarm, for example, one or a combination of the indicating text, the sound, and the lamplight, the alarm intensity related to at least one of the sound and the lamplight may be gradually increased as the executed time of the detection procedure becomes longer, but the present invention is not limited hereto, and a presenting manner of the alarm, for example, one or a combination of the indicating text, the sound, and the lamplight, may also be changed according to actual application demands.

Specifically, in other embodiments of the present invention, the MFP 10 may further include an identification module 111 and a network module 113. The identification module 111 is coupled to and controlled by the processing unit 105, for identifying an identity of the user. In addition, the network module 113 is coupled to and controlled by the processing unit 105, for sending the alarm, for example, the indicating text, to a computer device 20 corresponding to the user in an E-main manner through, for example, a wired or wireless network connection, when the processing unit 105 controls the alarm unit 109 to activate the alarm, for example, one or a combination of the indicating text, the sound, and the lamplight. Moreover, the content of the sent E-mail may include a network name and a placed location of the MFP 10, and the time of accomplishing the image capturing of the paper P by the MFP 10, but the present invention is not limited hereto.

In this manner, the user hears and/or sees the alarm, for example, one or a combination of the indicating text, the sound, and the lamplight at once, and learns/knows that the paper P is remained in the MFP 10, so that the user opens the TC of the MFP 10 to take away the paper P. After the user opens the TC of the MFP 10, the processing unit 105 controls the alarm unit 109 to turn off any alarm, for example, one or a combination of the indicating text, the sound, and the lamplight. It can be seen that the problem that the paper P is remained in the MFP 10 is effectively solved in this embodiment.

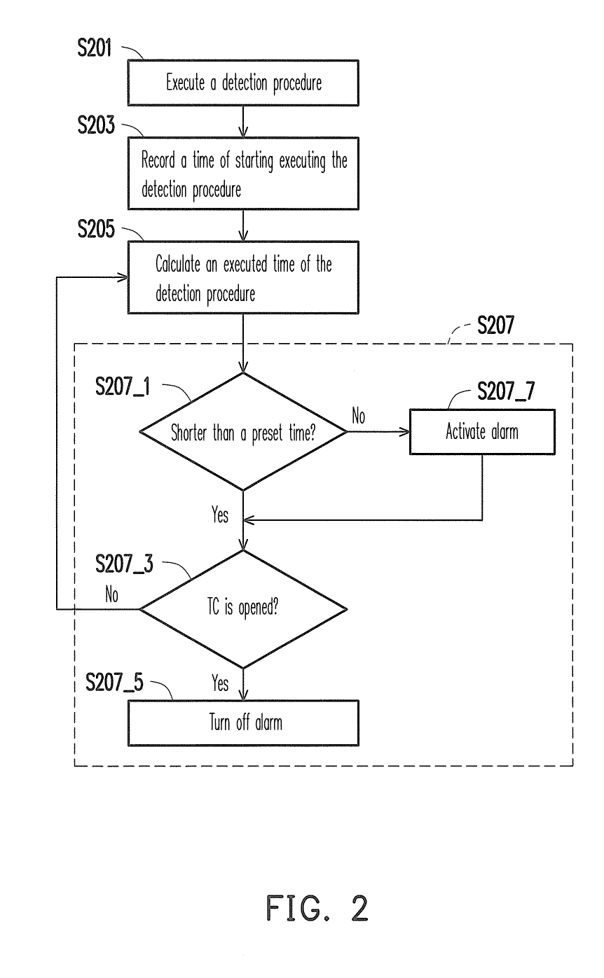

On the basis of the above embodiments, FIG. 2 is a flow chart of a method for detecting whether a paper is remained applicable to an MFP according to an embodiment of the present invention. Referring to FIG. 2, the method for detecting whether the paper is remained includes the following steps.

A detection procedure is executed, when the MFP accomplishes image capturing and outputting of the paper (Step S210).

A time of starting executing a detection procedure is recorded (Step S203).

An executed time of the detection procedure is calculated (Step S205).

It is determined whether to activate an alarm, for example, one or a combination of an indicating text, a sound, and a lamplight, according to the executed time of the detection procedure and whether a TC of the MFP is opened (Step S207), so as to remind a user whether the paper is remained in the MFP.

In this embodiment, Step S207 includes the following steps.

It is determined whether the executed time of the detection procedure is shorter than a preset time (Step S207_1).

It is further determined whether the TC of the MFP is opened (Step S207_3), when it is determined that the executed time of the detection procedure is shorter than the preset time in Step S207_1.

When it is determined that the TC of the MFP is opened in Step S207_3, the alarm, for example, one or a combination of the indicating text, the sound, and the lamplight, is turned off (Step S207_5), that is, the user does not forget the paper in the MFP; otherwise, the procedure returns to Steps S205 and S207_1, so as to determine whether the executed time of the detection procedure is shorter than the preset time.

When it is determined that the executed time of the detection procedure is not shorter than the preset time (that is, the executed time of the detection procedure is longer than the preset time) in Step S207_1, the alarm, for example, one or a combination of the indicating text, the sound, and the lamplight, is activated (Step S207_7) (that is, the user may forget the paper in the MFP), until the TC of the MFP is opened (that is, the user takes away the paper remained in the MFP).

In this embodiment, when the alarm, for example, one or a combination of the indicating text, the sound, and the lamplight, is activated in Step S207_7, the alarm intensity related to at least one of the sound and the lamplight may be gradually increased as the executed time of the detection procedure becomes longer, but the present invention is not limited hereto, and a presenting manner of the alarm, for example, one or a combination of the indicating text, the sound, and the lamplight, may also be changed according to the actual application demands.

More specifically, an identity recognition may exist between the MFP and the user, and a wired or wireless network connection may exist between the MFP and a computer device corresponding to the user. Thus, when the alarm, for example, one or a combination of the indicating text, the sound, and the lamplight, is activated in Step S207_7, the indicating text may be sent to the computer device corresponding to the user in an E-main manner through the wired or wireless network connection. In this manner, the user hears and/or sees the alarm, for example, one or a combination of the indicating text, the sound, and the lamplight, at once, and learns/knows that the paper is remained in the MFP, so that the user opens the TC of the MFP to take away the paper, thereby avoiding the problem that the paper is remained in the MFP.

In summary, in the present invention, when accomplishing the image capturing and the outputting of the paper, the MFP starts to detect whether the paper is remained in the MFP. Once detecting that the paper is remained in the MFP for a time exceeding the preset time, the MFP activates the alarm, for example, one or a combination of the indicating text, the sound, and the lamplight, so as to remind the user. In this manner, the problem that the paper is remained in the MFP is effectively solved. Although the MFP is taken as an example for description in the above embodiments, according to the spirit of the present invention, the method is also applicable to an independent and non-integrated scanning device or photocopying device, and the modified device subject matters still fall within the protection scope of the present invention.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents. Any embodiment of the present invention or the scope of the claim is not required to achieve all the objectives or advantages or features provided by the present invention. In addition, the abstract and the title are for the use of searching the patent file, and are not intended to limit the present invention.

What is claimed is:

1. A method for detecting whether a paper is remained, applicable to a multi-function printer (MFP), the method comprising:
executing a detection procedure, when the MFP accomplishes image capturing and outputting of the paper;
recording a time of starting executing the detection procedure;
calculating an executed time of the detection procedure; and
determining whether to activate an alarm according to the executed time of the detection procedure and whether a top cover (TC) of the MFP is opened, so as to remind a user whether the paper is remained in the MFP.

2. The method according to claim 1, wherein the step of determining whether to activate the alarm according to the executed time of the detection procedure and whether the TC of the MFP is opened comprises:
determining whether the executed time of the detection procedure is shorter than a preset time.

3. The method according to claim 2, wherein the step of determining whether to activate the alarm according to the executed time of the detection procedure and whether the TC of the MFP is opened further comprises:
further determining whether the TC of the MFP is opened, when determining that the executed time of the detection procedure is shorter than the preset time; and
turning off the alarm when the TC of the MFP is opened; otherwise, continuously determining whether the executed time of the detection procedure is shorter than the preset time.

4. The method according to claim 3, wherein the step of determining whether to activate the alarm according to the executed time of the detection procedure and whether the TC of the MFP is opened further comprises:
activating the alarm, when determining that the executed time of the detection procedure is not shorter than the preset time, until the TC of the MFP is opened.

5. The method according to claim 4, wherein the alarm comprises one or a combination of an indicating text, a sound, and a lamplight.

6. The method according to claim 5, wherein when the alarm is activated, an intensity of at least one of the sound and the lamplight is gradually increased as the executed time of the detection procedure becomes longer.

7. The method according to claim 5, wherein an identity recognition exists between the MFP and the user, a network connection exists between the MFP and a computer device corresponding to the user, and when the alarm is activated, the indicating text is sent to the computer device in an E-mail manner through the network connection.

8. A multi-function printer (MFP), comprising:
a scan module, for scanning a paper; and
a control module, coupled to the scan module, for controlling operation of the scan module, and detecting whether the paper is remained in the MFP according to an executed time of a detection procedure and whether a top cover (TC) of the MFP is opened, when the MFP accomplishes image capturing and outputting of the paper, so as to determine whether to activate an alarm to remind a user.

9. The MFP according to claim 8, wherein the control module comprises:
a processing unit, coupled to the scan module, for controlling the operation of the scan module, and executing the detection procedure when the MFP accomplishes the image capturing and the outputting of the paper;
a detection unit, coupled to the processing unit, and controlled by the processing unit, for detecting whether the TC of the MFP is opened; and
an alarm unit, coupled to the processing unit, and controlled by the processing unit, for determining whether to activate the alarm.

10. The MFP according to claim 9, wherein when the processing unit executes the detection procedure, the processing unit records a time of starting executing the detection procedure, calculates the executed time of the detection procedure, and determines whether to control the alarm unit to activate the alarm according to the executed time of the detection procedure and whether the TC of the MFP is opened.

11. The MFP according to claim 10, wherein when the processing unit determines that the executed time of the detection procedure is shorter than a preset time, the processing unit further controls the detection unit to determine whether the TC of the MFP is opened, and
when the processing unit determines that the TC of the MFP is opened, the processing unit controls the alarm unit to turn off the alarm; otherwise, the processing unit continuously determines whether the executed time of the detection procedure is shorter than the preset time.

12. The MFP according to claim 11, wherein when the processing unit determines that the executed time of the detection procedure is not shorter than the preset time, the processing unit controls the alarm unit to activate the alarm, until the TC of the MFP is opened.

13. The MFP according to claim 12, wherein the alarm comprises one or a combination of an indicating text, a sound, and a lamplight.

14. The MFP according to claim 13, wherein when the processing unit controls the alarm unit to activate the alarm, an intensity of at least one of the sound and the lamplight is gradually increased as the executed time of the detection procedure becomes longer.

15. The MFP according to claim 13, further comprising:
an identification module, coupled to and controlled by the processing unit, for identifying an identity of the user; and
a network module, coupled to and controlled by the processing unit, for sending the indicating text to a computer device corresponding to the user in an E-mail manner through a network connection, when the processing unit controls the alarm unit to activate the alarm.
